(19) United States
(12) Patent Application Publication
(10) Pub. No.: US 2007/0086768 A1
(43) Pub. Date: Apr. 19, 2007

(54) Method and image capture device for autofocus via specific light signal

(75) Inventor: Chinfu Hung, Taipei (TW)

Correspondence Address: BIRCH STEWART KOLASCH & BIRCH, PO BOX 747, FALLS CHURCH, VA, 22040-0747, US

(73) Assignee: PREMIER IMAGE TECHNOLOGY CORPORATION

(21) Appl. No.: 11/373,287

(22) Filed: Mar. 13, 2006

(30) Foreign Application Priority Data
Oct. 19, 2005 (TW) 094136542

(51) Int. Cl. G03B 13/00

(52) U.S. Cl. 396/106

(57) ABSTRACT

A method and image capture device for autofocus (AF) via a specific light signal, comprises the steps of: (a) emitting a light signal from an object in a scene to an image capture device, for example, a digital camera or a digital camcorder; (b) receiving and detecting the position of the light signal; (c) moving the lens of the image capture device to an acquired AF according to the position of the light signal; (d) setting the exposure and white balance data with weighting on the position of the light signal; and (e) capturing the image with the AF, exposure and white balance data. Therefore, even an unprofessional photographer can use such a device to focus on the object perfectly and rapidly.

### FIELD OF THE INVENTION

This invention relates to a method and image capture device for autofocus via a specific light signal, and more particularly, to a method of emitting a light signal from an object in the scene to an image capture device and setting the exposure and white balance data of the image capture device according to the position of the light signal.

### BACKGROUND OF THE INVENTION

Variety of digital image capture devices are widely used in digital camera (DC), digital video (DV) and camera mobile phone etc. In the related prior art, the field of study how to remove red eye and the field of study how to autofocus fast and precisely, both are of different topic and deemed not related to each other. This is the first notion to combine the both, to adopt the well developed method of red eye detecting and removing method into autofocus method for digital image capture device, to create a new autofocus method.

So called red eye is a natural phenomenon that while a flash light is reflected from the iris of mankind or animal and returns to the lens, it would happened accidentally. It is bad thing to the conventional camera, as it is difficult to prevent and remove; however, nowadays, to digital camera technology, the phenomenon of red eye can be detected and removed automatically via some of image processing method. Moreover, some of advanced digital camera can even detect the red eye and convert the image to normal while use it to take a picture. The image processing method generally comprises the steps of detecting the bright points which have some red eye features and removing the red eye automatically.

The device and processing method in U.S. Pub. No. US2005/0094894A1 to Takahiro et al, disclosed a method for checking the bright spots on a picture to find out suspected red eye point via a built-in program. The program functions for detecting the bright spots and searching a bright spots characteristic database and compare one by one, to find out the position of red eye. This method is much reliable and thus can prevent the chance of producing unusual color at the bright spots which is not red eye points.

Autofocus method for digital image capture device, generally it is performed according to the evaluation value resulted from an image signal. The evaluation value is obtained from the calculation of high frequency component which is obtained from the image signal passing through a band pass filter or a high pass filter. While moving the zoom lens, the high frequency components corresponded to each focus position are accumulated as a curve; a focus position is corresponding to the peak value of the curve and it is the focus point of the image capture device.

Autofocus mode in prior art can not lock on a specific object in the scene randomly and precisely, and can not set the white balance by calculated weighting on the object while it is moving or in still status. The autofocus mode for digital image capture device in prior art currently can not be always meet every needs of photographers while taking a picture of moving object, because the calculation area of the focus, exposure setting, and white balance are pre-fixed in a limited modes. For instance, there are including a cross center focus mode (11) as shown in FIG. 1A which can only focus on the center point of the image (10), and if the photographer wants to emphasize and focuse on the girl in the picture, and if the girl is running around and playing with the dog while taking a picture, the focus, exposure setting and white balance data may not always satisfy the photographer's expectation under such a cross center focus mode (11) of the prior art.

Another focus mode of the prior art which can only focus on the central area (12) as shown in FIG. 1B, and still one another focus mode on the entire area (13) as shown in FIG. 1C, those modes are not always satisfy the photographer's expectation while the object, like the girl and dog, are moving randomly as shown in the FIGS 1A, 1B and 1C.

Referring to FIG. 2, the focus method of prior art for image capture device comprises the steps of pushing down shutter button (21), actuating preset focus mode (22), proceeding the autofocus mode (23) to focus on a preset area of the focus mode and setting white balance and exposure (24) according to the preset area; and capturing a digital image (25).

The focus module of the prior art as shown in FIG. 1A, 1B and 1C, all are lacking of the function designed for photographers to catch and lock the object rapidly as their wish. To improve the autofocus method and catch the object to be more rapidly and precisely are one of long standing goals which is pursuing by digital image capture device designer.

### SUMMARY OF THE INVENTION

In order to achieve a breakthrough for the unresolved problems as the aforementioned, a new method of autofocus to combine with the well developed red eye detecting technology is provided by the present invention for digital image capture device, it is capable of catching and locking on an still or moving object in a scene precisely and rapidly, and setting white balance and exposure weighting on the object.

In order to achieve the goal as stated above, a method according to the present invention comprises the steps of: (a) emitting a light signal from an object in the scene to an image capture device, for example, a digital camera and a digital camcorder; (b) receiving and detecting the position of the light signal; (c) moving the lens of the image capture device to an acquired autofocus (AF) according to the position of the light signal; (d) setting the exposure and white balance data while gave a suitable weighting on the position of the light signal; and (e) capturing the image with the AF, exposure and white balance data. The method of emitting the light signal initiatively from the scene makes the image capture device to give a suitable weighting on the object more fast and accurately. Therefore, the image of the object can be showed perfectly and clearly.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1A is a schematic view showing one of an autofocus mode of the prior art.

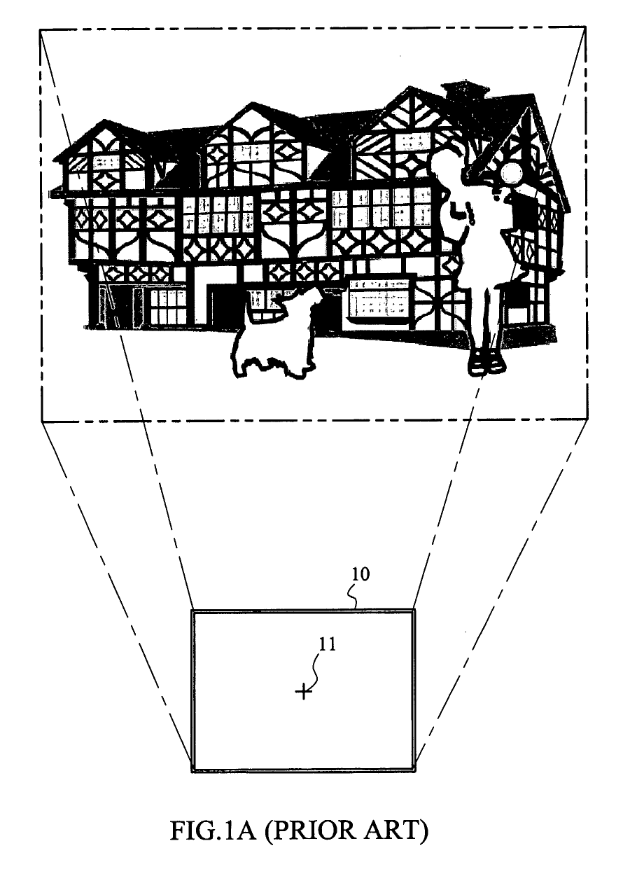

FIG. 1B is a schematic view showing other autofocus mode of the prior art.

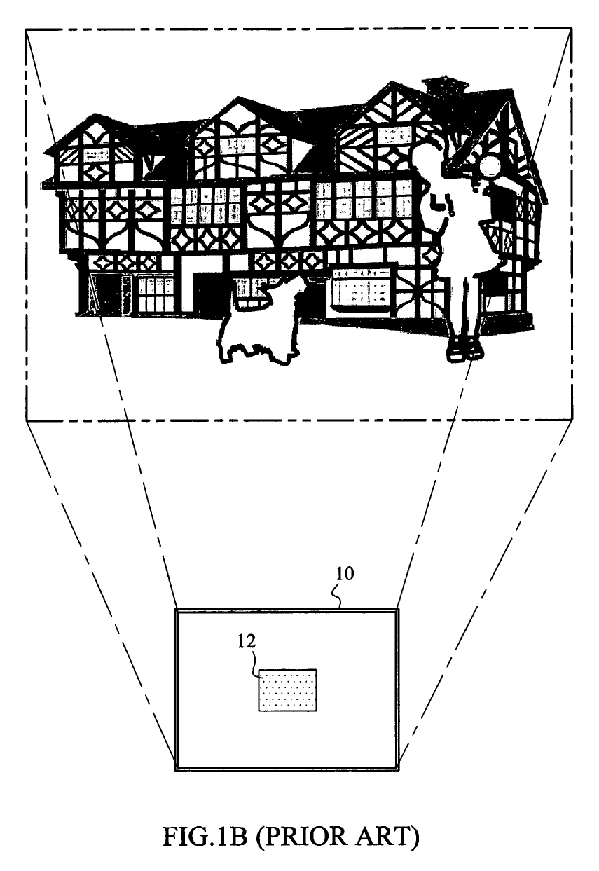

FIG. 1C is a schematic view for showing another autofocus mode of the prior art.

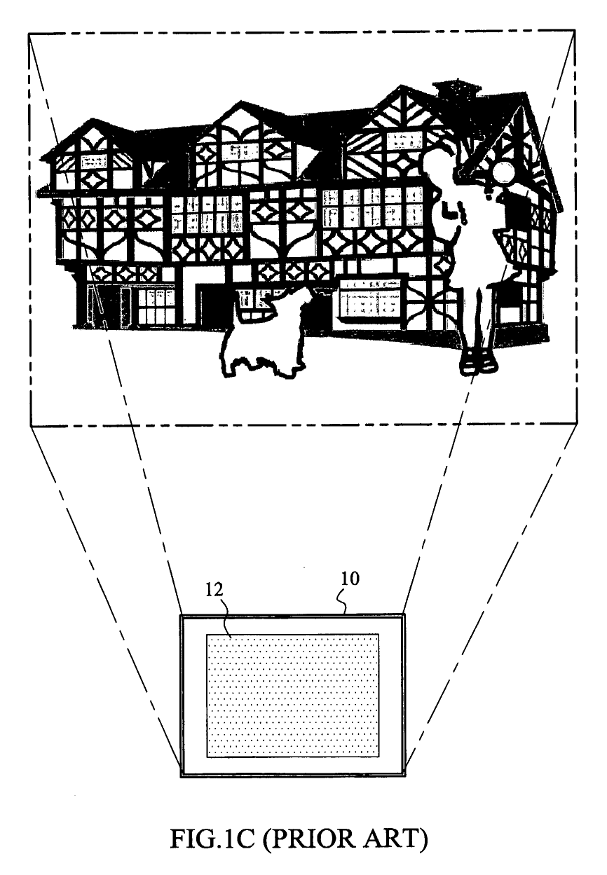

FIG. 2 is a flow chart showing the autofocus method of the prior art.

FIG. 3 is a an embodiment of flow chart of the autofocus method according to the present invention.

FIG. 4 is a schematic view illustrating an autofocus mode according to the present invention.

FIG. 5 is a flow chart of autofocus method of another embodiment according to the present invention.

FIG. 6 is a block diagram for illustrating an image capture device of a preferred embodiment according to the present invention.

### DETAILED DESCRIPTION OF THE PREFERRED EMBODIMENTS

To better understand to the purposes, benefits and features of the present invention, the preferred embodiment of the present is disclosed for further illustration accompanied with the drawings below:

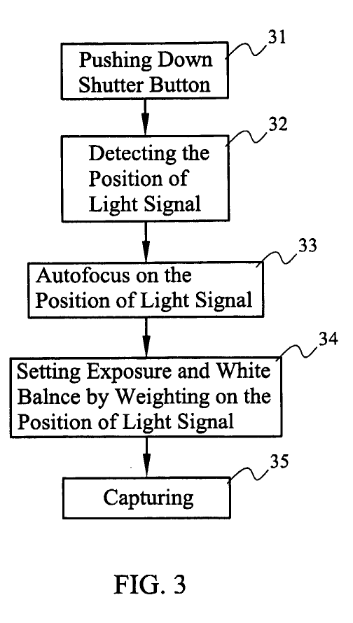

FIG. 3 is a flow chart illustrating a autofocus method in accordance with the present invention, including the steps of pushing down shutter button (31) to start image capture device to receive and detect a light signal position (32), moving the lens of image capture device for autofocus on the position of light signal (33), setting exposure and white balance by weighting on the position of light signal (34) and capturing (35) to obtain a digital image.

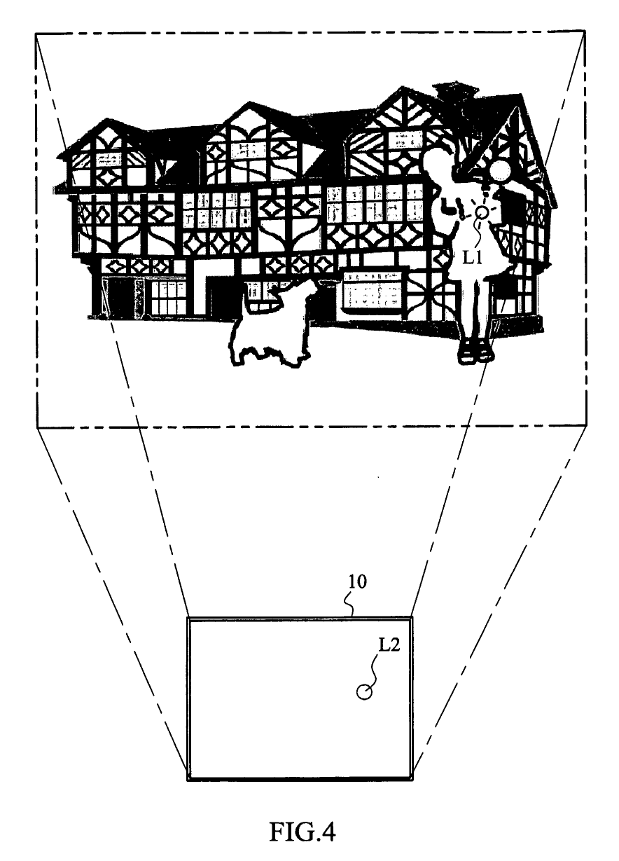

While a photographer is taking a photo by the embodiment of the image capture device according to the present invention, can let the object, like the girl or dog in FIG. 4, to wear or carry a light source such as a shinning decoration, flashlight, or Light Emitting Diode (LED), and to emit a light signal (L1) from the scene. The light signal (L1) is then received by the image capture device and the position (L2) on the image (10) can then be detected and located; the lens of the image capture device is moved to reach a focus position which is calculated according to the position (L2) of light signal (L1). Preferably, the setting of exposure and white balance setting are weighting on the position (L2) to obtain a suitable image of the object.

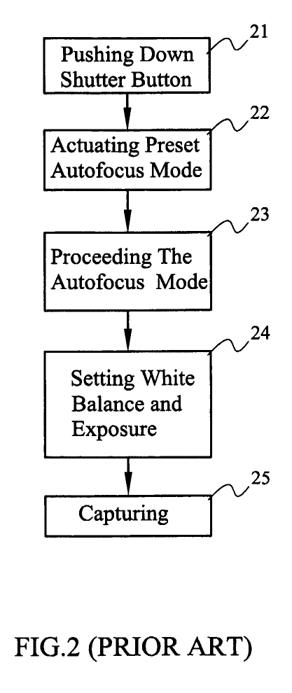

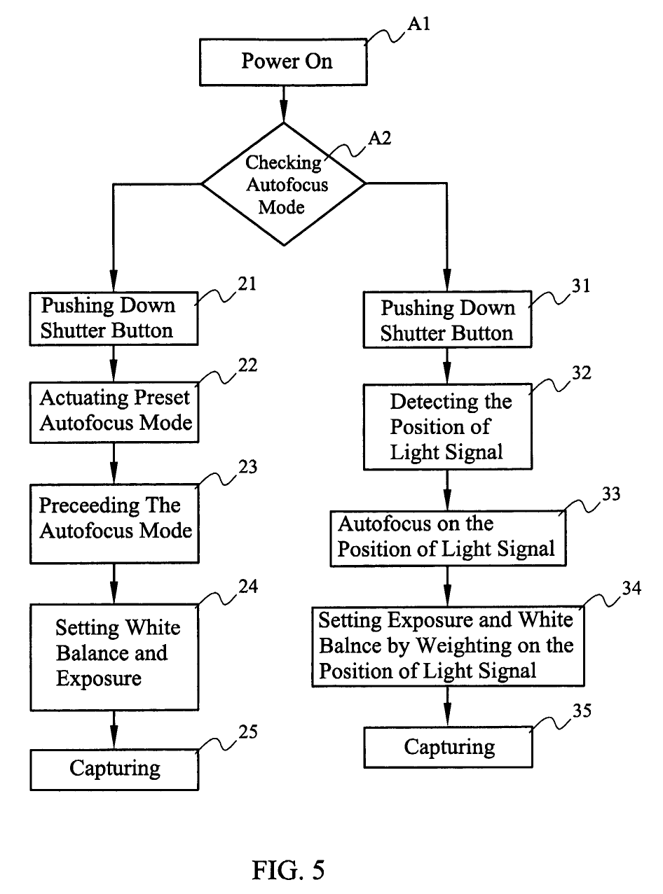

A person who skilled in this art would know, the application of the method according to the present invention can be integrated with other autofocus mode of prior art; for instance, an alternative embodiment of the present invention as being illustrated in FIG. 5 combined with the method of FIGS. 2 and 3 by adding the steps of (A1) and (A2). The flowchart starts from the steps of power on (A1) and checking autofocus mode (A2) which is selected by the photographer, and executing either the steps of FIGS. 2 or 3.

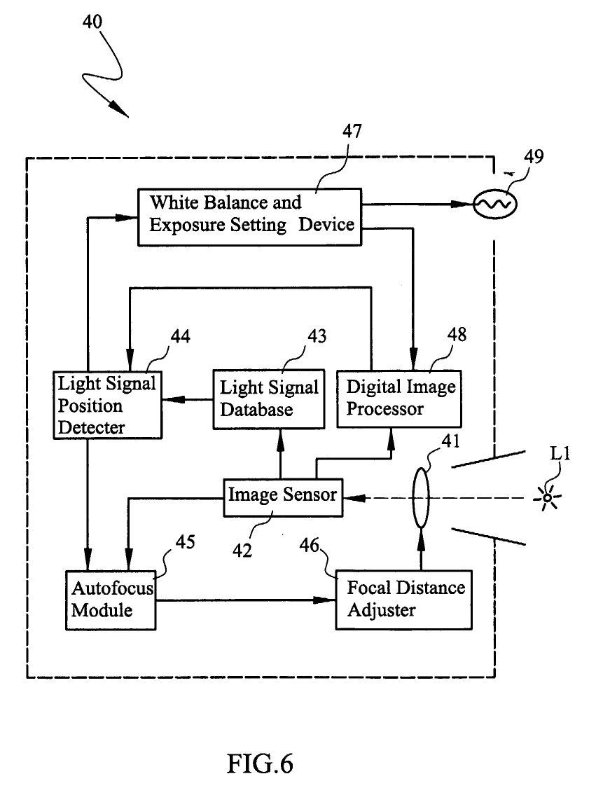

Referring to FIG. 6, a block diagram illustrating an image capture device (40) of the preferred embodiment according to the present invention comprises a lens (41), an image sensor (42), a light signal database (43), a light signal position detecter (44), an autofocus module (45) including a focal distance adjuster (46) for moving the lens (41), a white balance data and exposure setting device (47), a digital image processor (48) and a flash lamp (49).

The light signal (L1) can be of visible or invisible light source to human, but would be sensible to image sensor (42). The device used to emit light signal (L1) can be a shining decorations of people, flashlights or the luminous bodies of all kinds of colors such as LED. Besides, in order to identify more categories of light signal (L1), it would be better to provide with a light signal (L1) learning function. The learning function including to memory a plurality of light signal (L1) to form a light signal database (43) via the lens (41) and the image sensor (42) and store as samples stored in a memory device. The light signal position detecter (44) compares some of suspected bright points in image with the samples to identify the bright point of the light signal (L1).

While taking a photo, the light signal position detecter (44) detects a digital image from image sensor (42) via digital image processor (48). The light signal database containing light signal samples for identifying the position of the light signal (L1) in the image. The autofocus module (45) calculates the focus condition according to the position of the light signal (L1) and sends a command to the focal distance adjuster (46) to move the lens (41) to a suitable focus position. A focus image is resulted via the digital image processor (48) according to the position of the light signal (L1) while the lens (41) is moved to the focus position. In the meantime, the white balance data and exposure setting device (47) is preferably giving a weighting on the position of the light signal (L1) while setting the white balance and exposure of the image. If the image is detected of underexposure, the flash lamp would be actuated promptly.

While the steps according to the position of the light signal (L1) are completed, the digital image processor (48) converts the image into digital image signal for further coding, compressing, saving and output.

A person who skilled in this art would know that the block diagram of said preferred embodiment can also be a firmware which is equipped on hardware; for instance, the light signal position detecter (44) can be a firmware in a digital image processor (48). The light signal database (43) can be stored in a memory unit without extra cost of components.

The digital image processor (48) and the focus method according to the present invention are having the advantages of:

1. the method of the present invention providing a new, faster, alternative choice of focus mode.

2. the method of the present invention detecting the position of light signal, and thus can focus on the position of object precisely and rapidly.

3. the method of the present invention can emphasize a main portion in the scene or an object, and focus automatically on where the light signal is detected, and give a suitable weighting on exposure setting to avoid underexposure or overexposure of the object. Meanwhile, the while balance data can be set properly by weighting without hue errors of the object.

In addition, while the photographers is using the embodiment of the present invention to take the photo or video of a moving object, it is preferably to let the object bearing a light source to emit light signal (L1). Although the bright spots of light signal (L1) may appeared on the video, however a person who is skilled in this art would known how to erase the bright spot, such as the method for removing the red eye from an image. While taking a still image, the light signal (L1) can be turn off after the focus has been completed and then capturing the image.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for image capture device for autofocus via a specific light signal comprising the steps of: emitting a light signal from a scene; proceeding an autofocus function of the image capture device according to the position of the light signal; and capturing an image.

2. The method of claim 1, further comprising a step of setting exposure and white balance of the image, wherein the setting is claculated by weighting on the position of the light signal.

3. The method of claim 1, wherein the step of proceeding the autofocus function according to the position of the light signal includes a step of detecting the position of the light signal by a light signal position detecter.

4. The method of claim 3, wherein the light signal position detecter performing a step of searching a light signal database via a programmed firmware in the image capture device.

5. The method of claim 3, further comprising a step of comparing the light signal detected by the light signal position detecter with a light signal database to identify the light signal from a plurality of suspected bright points and detect the position of the light signal.

6. The method of claim 5, wherein the step of comparing the light signal includes a step of searching the light signal database from a memory unit.

7. A method for image capture device for autofocus via a specific light signal comprising the steps of: receiving the light signal form a light source in a scene; detecting the position of the light signal; proceeding an autofocus function; setting an exposure and white balance according to the position of the light signal; and capturing an image.

8. The method of claim 7, wherein the step of receiving light signal includes receiving visible light and invisible light which can be detected by an image sensor.

9. The method of claim 7, wherein the step of receiving light signal includes receiving a light from a shinning decorations.

10. The method of claim 7, wherein the step of receiving light signal includes receiving a light from a flashlight.

11. The method of claim 7, wherein the step of receiving light signal includes receiving a light from a Light Emitting Diode (LED).

12. The method of claim 7, wherein the step of setting of the exposure and white balance are calculated weighting on the position of the light signal.

13. The method of claim 7, wherein the step of detecting the position of the light signal is performed by a light signal position detecter.

14. The method of claim 13, wherein the light signal position detecter performing the step of searching by a programmed firmware in the image capture device.

15. A image capture device for autofocus via a specific light signal, comprising:
a lens for capturing an image and a light signal in a scene;
an autofocus module for moving the lens to a focus position according to the position of the light signal;
an image sensor for detecting the light of image and the light signal via the lens and transferring both of the lights into an image;
a light signal position detecter for detecting the position of the light signal in the image, and providing the position to the autofocus module; and
a white balance and exposure setting device for setting a white balance data and exposure of the image.

16. The image capture device of claim 15, further comprising a light signal database, said light signal database having a plurality of comparison samples of light signal, wherein the light signal position detecter using the samples to identify and detect the position of the light signal.

17. The image capture device of claim 15, wherein the light signal position detecter includes a firmware programmed in the image capture device.

18. The image capture device of claim 15, wherein the white balance and exposure setting device set the white balance data and exposure by weighting on the position of the light signal provided by the light signal position detecter.
